(19) United States
(12) Patent Application Publication
(10) Pub. No.: US 2012/0256926 A1
(43) Pub. Date: Oct. 11, 2012

(54) GESTURE, TEXT, AND SHAPE RECOGNITION BASED DATA VISUALIZATION

(76) Inventors: ANDRES MARTIN JIMENEZ, Dublin (IE); Louay Gargoum, DB Killiney (IE); Tony O'Donnell, KD Kildare Town (IE)

(21) Appl. No.: 13/082,508

(22) Filed: Apr. 8, 2011

(51) Int. Cl. G06T 11/20

(52) U.S. Cl. 345/440

(57) ABSTRACT

Various embodiments of systems and methods for gesture, text, and shape recognition based data visualization are described herein. The technique allows quick show of graphic representations of data in a very intuitive user interface, focusing on devices such as but not limited to touchable screens and interactive white boards. In one aspect, a shape recognition engine transforms strokes into charts and a text recognition engine transforms text queries into actual data queries. Then the output from the two engines is combined into a graphic representation of data.

### FIELD

The field relates to gesture, text, and shape recognition. More precisely, the field relates to gesture, text, and shape recognition based data visualization.

### BACKGROUND

Data visualization is visual representation of data. The main goal of data visualization is to communicate information clearly and effectively through graphical means. Both aesthetic form and functionality need to go hand in hand, providing insights into a rather sparse and complex data set by communicating its key aspects in a more intuitive way. Designers often fail to achieve a balance between design and function by creating gorgeous data visualizations, which fail to perform their main purpose to communicate information.

Gesture, text, and shape recognition appeared to be among the major techniques facilitating the user experience in the world of constantly evolving computer environment. Gestures are implemented intuitively for performing certain actions in a user interface environment where user intervention is allowed. Text recognition is also widely used. Text recognition is based on character recognition and word recognition. Shape recognition is automatic analysis of geometric shapes. It may be used in many fields such as archeology, architecture, and medical imaging.

Many devices having touchable screens or interactive white boards are used to visually present data. Such devices presume the use of techniques that may provide quickly desired graphical representations of data in a very intuitive user interface.

### SUMMARY

Various embodiments of systems and methods of gesture, text, and shape recognition based data visualization are described herein. In one embodiment, the method includes receiving a user interaction defining a shape input and transforming the shape input into a chart definition. The method also includes displaying a graphic representation based on the chart definition and receiving a user interaction defining a text input. The method further includes transforming the text input into a query to a database and presenting data retrieved on the query into the graphic representation based on the chart definition.

In other embodiments, the system includes at least one processor for executing program code and memory, a first input device to receive user interaction defining a shape input, and a second input device to receive user interaction defining a text input. The system also includes a repository within the memory to persist a database, a shape recognition module to recognize the shape input and define a chart according to the shape input, and a text recognition module to transform the text input into a query to the database. The system further includes a display to show the chart according to the shape input with data retrieved on the query to the database.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing an embodiment of a system of gesture, text, and shape recognition based data visualization.

FIG. 2 is a flow diagram of an embodiment of a method of gesture, text, and shape recognition based data visualization.

FIG. 3 is a block diagram of an embodiment of a system of gesture, text, and shape recognition based data visualization.

FIG. 4A illustrates receiving strokes resembling a circle as a shape input according to an embodiment of the invention.

FIG. 4B illustrates chart definition according to an embodiment of the invention.

FIG. 5A illustrates receiving text input according to an embodiment of the invention.

FIG. 5B illustrates presentation of queried data as a chart diagram according to an embodiment of the invention.

FIG. 6 is a block diagram illustrating a computing environment in which the techniques described for gesture, text, and shape recognition based data visualization can be implemented, according to an embodiment of the invention.

### DETAILED DESCRIPTION

Embodiments of techniques for gesture, text, and shape recognition based data visualization are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

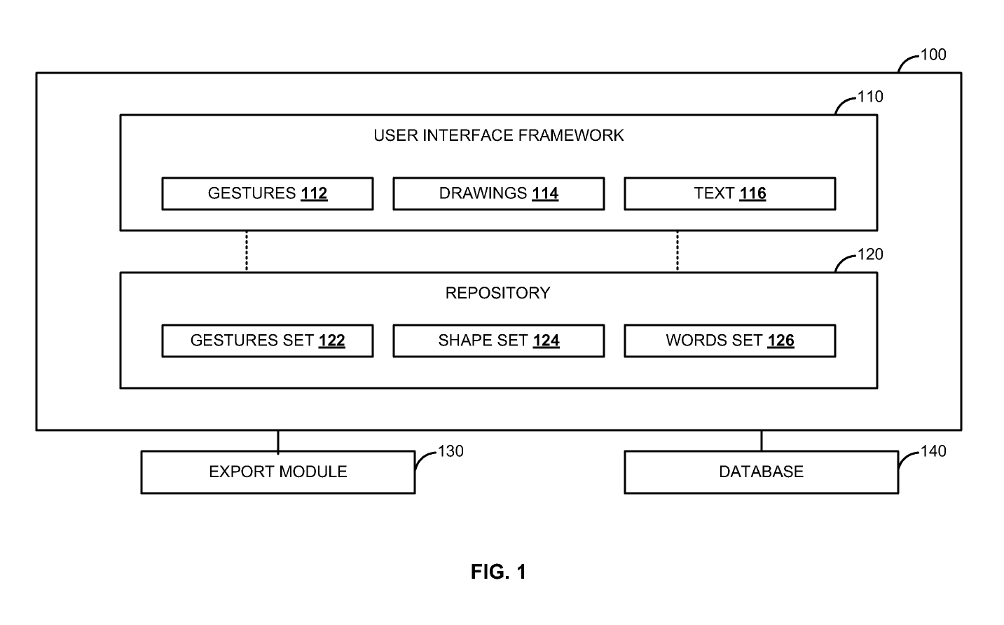

FIG. 1 represents a block diagram of an embodiment of a system 100 of gesture, text, and shape recognition based data visualization. The system 100 includes a user interface framework 110. The user interface framework 110 is designed to receive gestures 112, drawings 114, and text 116 from a user operating on the system 100. In one embodiment, the gestures 112, drawings 114, and text 116 are received by the way of input devices (not shown) to the system 100. The input devices may be such as pointing devices, touchable screens, and keyboards. Pointing devices and touchable screens are intended to facilitate user interaction in receiving gestures 112 and drawings 114. Keyboards are primarily used for receiving text input such as text 116.

The user interface framework 110 communicates with the repository 120. The repository 120 includes gestures set 122, shape set 124, and word set 126. The gestures set 122 includes set of gestures that are recognizable by the system 100. Recognized gestures are gestures 112 received by the user interface framework 110 through gestures 112 and matched to the gestures set 122 in the repository 120. Gestures that are present in the gestures set 122 are known to the system 100 and may lead to some actions performed by the system 100. Such actions may be, for example, opening, closing, moving, deleting, rotating, expanding, and contracting elements in the user interface. In more complex user interface environments depending on the data presented in the user interface, gestures 112 may be assigned to changing the data representation, for example turning from 2-dimensional to 3-dimensional image and vice versa. In a business environment when different dimensions of data are presented, gestures 112 could be assigned to drilling-down and drilling-up to different dimensions, opening contextual menus, etc.

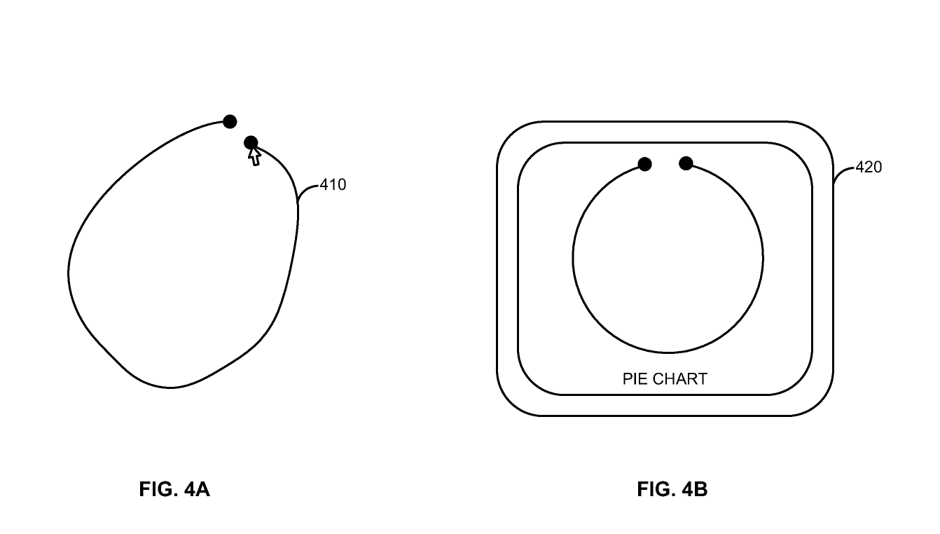

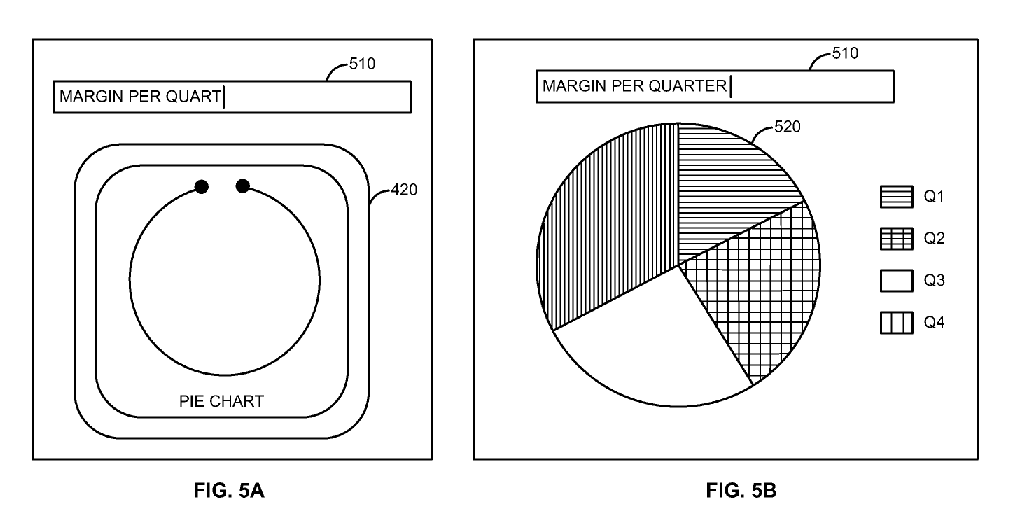

The shape set 124 includes shapes that are recognizable by the system 100. Recognized shapes are shapes received by the user interface framework 110 through drawings 114 and matched to the shape set 124 in the repository 120. Shapes that are present in the shape set 124 are known to the system 100 and may be depicted on request. For example, if strokes resembling a circle are received as drawings 114 (see FIG. 4A), and the shape circle is known to the system 100, the system 100 will automatically recognize the shape and match the shape to its corresponding one in the shape set 124. In one embodiment, when in the system 100, a user input as in FIG. 4A is received through drawings 114, the system 100 matches the shape to an instance of predefined charts persisted in the shape set 124. Intuitively, the shape input received through drawings 114 should resemble the desired chart in shape set 124. For example, the corresponding chart to the strokes 410 in FIG. 4A may be the pie chart diagram 420 in FIG. 4B. Thus, system 100 may intuitively depict a chart diagram upon a shape input resembling the desired chart diagram. Turning back to FIG. 1, the word set 126 within the repository 120 includes words that are recognizable by the system 100. Recognized words are received by the user interface framework 110 through text 116 and matched to the words set 126. Recognizing a word received through text 116 and matching it to the words set 126 may cause the system to perform an action presumed by the word itself. In one embodiment, words received through text 116 are transformed to a query to a database 140. For example, text 116 is received as shown in FIG. 5A in the field 510. Recognized words are matched to words set 126, the words set 126 comprising fields in the database 140 to create query to the database 140. Thus, text input received through text 116 may be automatically transformed to a query to a database 140 by matching words received from text 116 to words in the words set 126 predefined to query the database 140. The database 140 may be internal (not shown) or external to the system 100.

The export module 130 is intended to connect the system 100 to an external system (not shown). In one embodiment, the system 100 is connected through export module 130 as a plug-in to an external system.

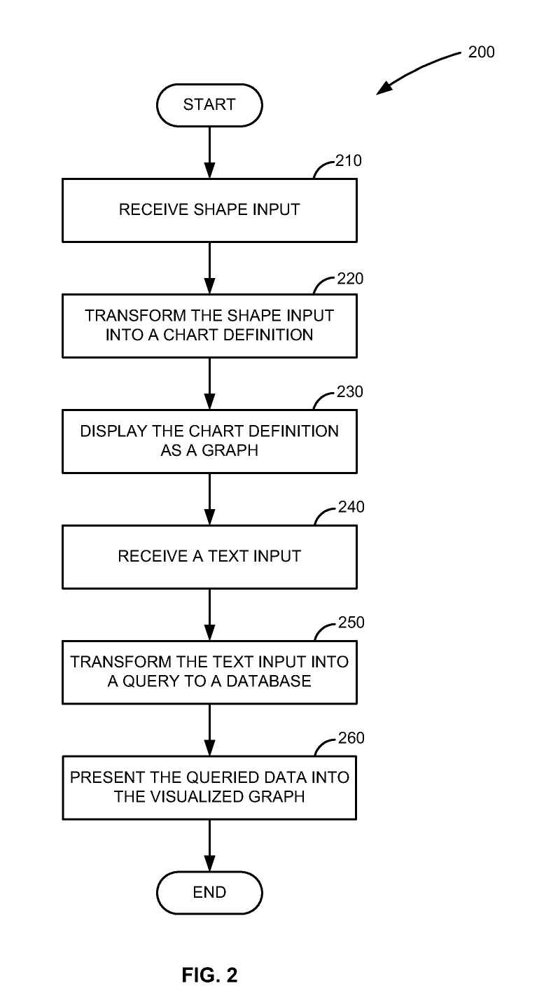

FIG. 2 is a flow diagram of an embodiment of a method 200 of gesture, text, and shape recognition based data visualization. The method begins at block 210 with receiving a shape input. The shape input is received by means of a user interaction defining a shape input. In one embodiment, strokes resembling an instance of predefined shapes are received as shape input. The strokes may be drawn by the way of any pointing input device such as mouse, touch pad or touch screen. For example, strokes 410 resembling a circle are received as shown in FIG. 4A. Further, at block 220, the shape input is transformed into a chart definition. In one embodiment, the chart definition is performed by recognizing the shape input and matching the recognized shape input to an instance of predefined charts. For example, the shape input 410 as shown in FIG. 4A is transformed to pie chart definition 420 as shown in FIG. 4B. Because the shape input 410 resembles a circle, the shape input 410 is transformed intuitively to a pie chart definition 420, as depicted in FIG. 4B. Similarly, if columns are received as shape input, column chart is the intuitive chart definition. Another example is if line is received as a shape input, then the chart definition is supposedly line chart.

Turning back to FIG. 2, at block 230, a graphic representation is displayed based on the chart definition. In one embodiment, the graphic representation is a chart according to the chart definition. For example, pie chart definition 420 as in FIG. 4B is displayed as a pie chart graphic representation such as pie chart 520 in FIG. 5B. Next, at block 240, a text input is received. In one embodiment, the text input defines desired data to be displayed in the graphic representation depicted in block 230. In the illustration presented in FIG. 5A, text input 510 is received next to the pie chart definition 420, so that the text input is to define the data to be presented in a pie chart. Then, at block 250, the text input is transformed into a query to a database. In one embodiment, the text input is parsed for defining text elements necessary for the query to the database. For example, text input 510 in FIG. 5A is a natural text. By parsing this natural text as shown in text input 510, a query based on the text input may be generated.

Turning again to FIG. 2, at block 260, the queried data is presented into the graphic representation depicted in block 230. For example, chart 520 in FIG. 5B represents the data queried based on text input 510.

In one embodiment, the graphic representation is updated, when the queried database is changed. This means that if the data residing in the database is changed and this data had been queried and presented as a chart, the graphic representation of the data is updated automatically. In yet another embodiment, the graphic representation is updated, when a new shape input is received, thus defining new chart according to the new shape input.

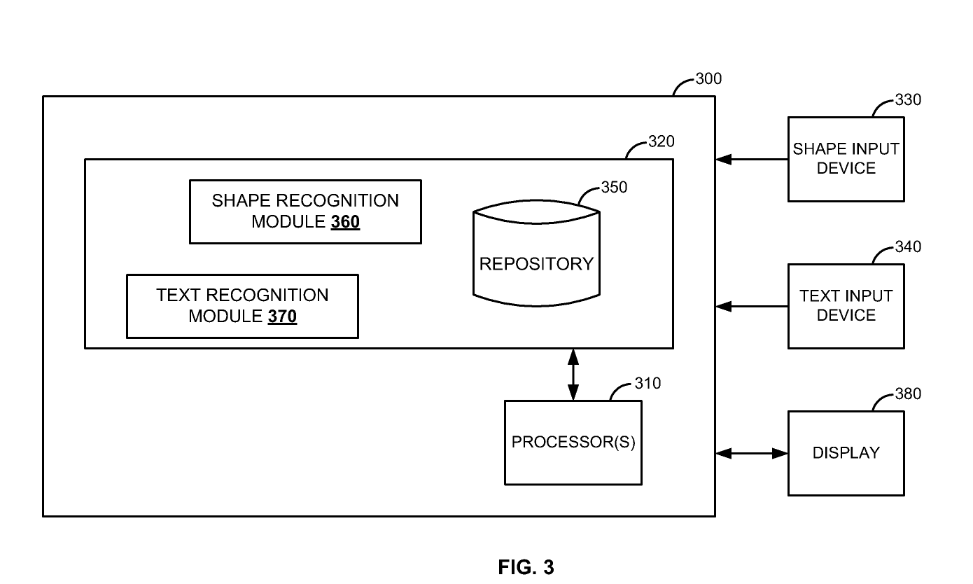

FIG. 3 is a block diagram of an embodiment of a system 300 of gesture, text, and shape recognition based data visualization. The system includes one or more processors 310 for executing program code. Computer memory 320 is in connection to the one or more processors 310. The system 300 further includes a repository 350 within the memory 320 to persist a database. In one embodiment the database consists of business data.

A shape input device 330 and a text input device 340 are connected to the system 300. In one embodiment, the shape input device 330 is a pointing input device used for drawing strokes resembling shapes. In yet another embodiment, the pointing input device is a mouse, a touch pad or a touch screen. In one embodiment, the text input device 340 is a keyboard or a touch screen display providing opportunity for typing.

The memory 320 also includes a shape recognition module 360 and a text recognition module 370. The shape recognition module is intended to recognize the shape input received by the shape input device 330 and define a chart according to the shape input. In one embodiment, the shape recognition module compares strokes received through the shape input device 330 with predefined charts. For example, if a shape input of columns is received through shape input device 330, the shape recognition module 360 defines the shape as a column and relates the shape input to a column chart having the same shape. The shape input may not be only related directly to a chart having the same shape. In one embodiment, the shape input is, for example, a flag. The shape recognition module 360 recognizes the shape as a flag but defines a map chart. Such matching relationship is predefined and based on intuitive approach. Typically the shape input resembles a chart element or the whole chart performance. In one embodiment, a set of predefined charts is persisted in the database within the repository 350.

The text recognition module 370 is intended to transform text received through the text input device 340 into a query to the database within the repository 350. In one embodiment, the text is a natural text parsed to define text elements necessary for the query to the database within the repository 350. For example, a text input is received through text input device 340. The received text input is parsed to define word elements necessary for creating a query to the database within the repository 350

The system further includes a display 380. The display 380 is intended to show the chart according to the shape input with data retrieved on the query to the database. In one embodiment, the display 380 is a touch screen display. In yet another embodiment, the touch screen display coincides with the shape input device 330 and the text input device 340.

FIG. 4A and FIG. 4B illustrate shape recognition according to one embodiment. If a shape input is received such as shape input 410, a system such as system 300 defines this shape input 410 as a circle. The shape input 410 may be received by a shape input device 330. In one embodiment, the shape input device 330 is a pointing input device or touch screen. The shape definition is performed through known techniques for shape recognition. In one embodiment, a special module such as shape recognition module 360 is used for defining the shape input 410. When the shape input 410 is defined, a chart type is depicted such as pie chart definition 420 in FIG. 4B. Thus the shape input 410 is not only recognized but also used for defining a chart type for presenting data.

FIG. 5A and FIG. 5B illustrate text recognition according to one embodiment. Text input 510 is received through a text input device such as text input device 340. In one embodiment the text input device 340 is a keyboard for typing text. In another embodiment, a display such as display 380 is a touch screen and may be used for typing text in a touch screen keyboard. The text input 510 is transformed into a query to a database. In one embodiment, a specifically designed module such as text recognition module 370 is used for text recognition. In one embodiment the text input 510 is parsed for defining word elements necessary for querying a database. When a query is defined, a chart, such as chart 520 in FIG. 5B is depicted. Thus the text input 510 is recognized and used for presenting data defined by the text input 510.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

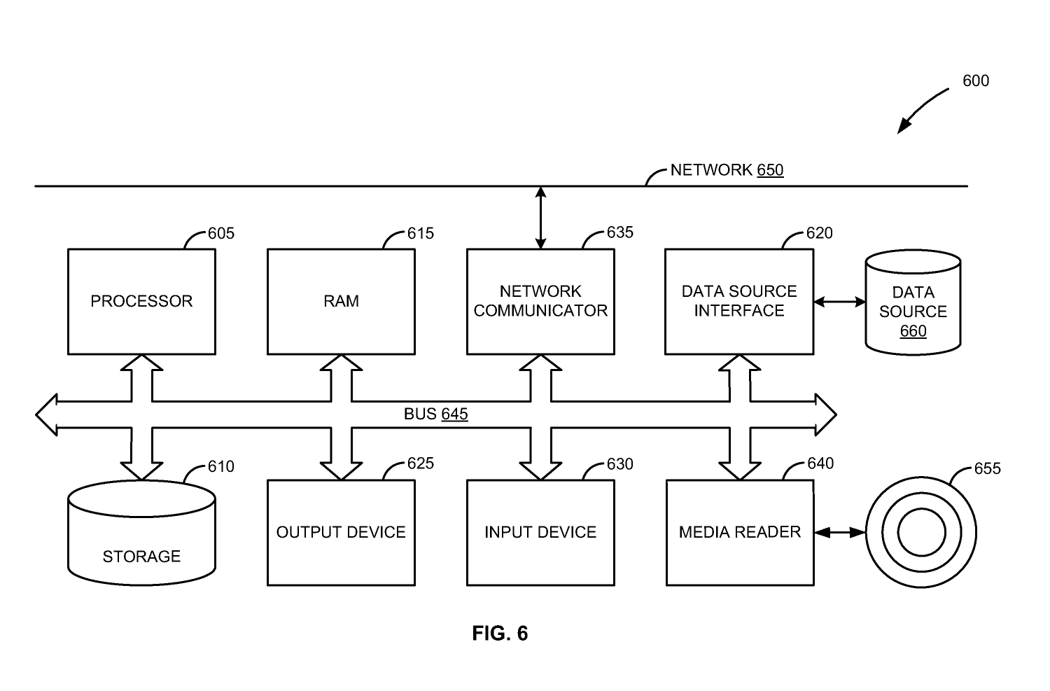

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method of data visualization and interaction comprising:
receiving a user interaction defining a shape input;
transforming the shape input into a chart definition;
displaying a graphic representation based on the chart definition;
receiving a user interaction defining a text input;
transforming the text input into a query to a database; and
presenting data retrieved on the query into the graphic representation based on the chart definition.

2. The method of claim 1, wherein receiving the user interaction definitions of the shape input further comprises receiving strokes resembling an instance of predefined shapes.

3. The method of claim 1, wherein transforming the shape input into a chart definition further comprises recognizing the shape input and matching the recognized shape input to an instance of predefined charts.

4. The method of claim 1, wherein displaying a graphic representation based on the chart definition further comprises displaying a chart according to the chart definition in a graphical user interface.

5. The method of claim 1, wherein receiving a user interaction defining a text input further comprises receiving text input defining desired data to be displayed in the graphic representation based on the chart definition.

6. The method of claim 1, wherein transforming the text input into a query to a database further comprises parsing the text input for defining text elements necessary for the query to the database.

7. The method of claim 1, further comprising updating the data in the graphic representation when the queried database is changed.

8. A computer system for data visualization and interaction including at least one processor for executing program code and memory, the system comprising:
a first input device to receive user interaction defining a shape input;
a second input device to receive user interaction defining a text input;
a repository within the memory to persist a database;
a shape recognition module to recognize the shape input and define a chart according to the shape input;
a text recognition module to transform the text input into a query to the database; and
a display to show the chart according to the shape input with data retrieved on the query to the database.

9. The system of claim 8, wherein the first input device is a pointing input device used for drawing strokes resembling shapes.

10. The system of claim 8, wherein the second input device is a keyboard.

11. The system of claim 8, wherein the database comprises business data.

12. The system of claim 8, wherein the text recognition module parses the text input to define text elements necessary for the query to the database.

13. The system of claim 8, wherein the display is a touch screen display.

14. An article of manufacture including a non-transitory computer readable storage medium to tangibly store instructions, which when executed by a computer, cause the computer to:
receive a user interaction defining a shape input;
transform the shape input into a chart definition;
display a graphic representation based on the chart definition;
receive a user interaction defining a text input;
transform the text input into a query to a database; and
present data retrieved on the query into the graphic representation based on the chart definition.

15. The article of manufacture of claim 14, wherein the instructions to receive the user interaction definitions of the shape input further comprise instructions, which when executed by a computer, cause the computer to receive strokes resembling an instance of predefined shapes.

16. The article of manufacture of claim 14, wherein the instructions to transform the shape input into a chart definition further comprise instructions, which when executed by a computer, cause the computer to recognize the shape input and match the recognized shape input to an instance of predefined charts.

17. The article of manufacture of claim 14, wherein the instructions to display a graphic representation based on the chart definition further comprise instructions, which when executed by a computer, cause the computer to display a chart according to the chart definition in a graphical user interface.

18. The article of manufacture of claim 14, wherein the instructions to receive a user interaction defining a text input further comprise instructions, which when executed by a computer, cause the computer to receive text input defining desired data to be displayed in the graphic representation based on the chart definition.

19. The article of manufacture of claim 14, wherein the instructions to transform the text input into a query to a database further comprise instructions, which when executed by a computer, cause the computer to parse the text input for defining text elements necessary for the query to the database.

20. The article of manufacture of claim 14, further comprising instructions, which when executed by a computer, cause the computer to update the data in the graphic representation when the queried database is changed.
